(19) United States
(12) Patent Application Publication
(10) Pub. No.: US 2008/0054034 A1
(43) Pub. Date: Mar. 6, 2008

(54) Rack ingas

(75) Inventor: Craig Matthew Winston, Sandpoint, ID (US)

Correspondence Address: CRAIG WINSTON, 1064 WEST SHINGLE MILL RD., SANDPOINT, ID, 83864, US

(73) Assignee: Rack in Gas, Sandpoint, ID (US)

(21) Appl. No.: 11/370,092

(22) Filed: Sep. 1, 2006

(51) Int. Cl. B60R 9/00

(52) U.S. Cl. 224/402

(57) ABSTRACT

A rack which is provided for a pickup truck or trailer: includes brackets which are fastened to any application to carry a 5 U.S. gallon square gas can. There is a bar that slides through the handle of the gas can to be locked in place.

### DESCRIPTION

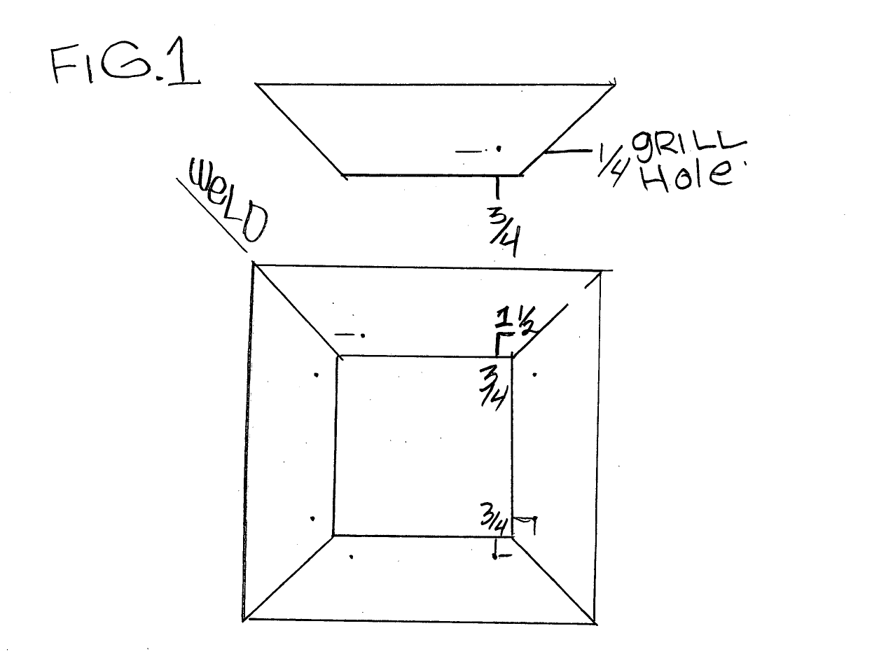

FIG. 1. An Isometric view of the invention the square gas can rack:

Angle iron is cut into 4 separate pieces cut for base of invention mounted down, 8 holes drilling angle iron option mounting upright safety.

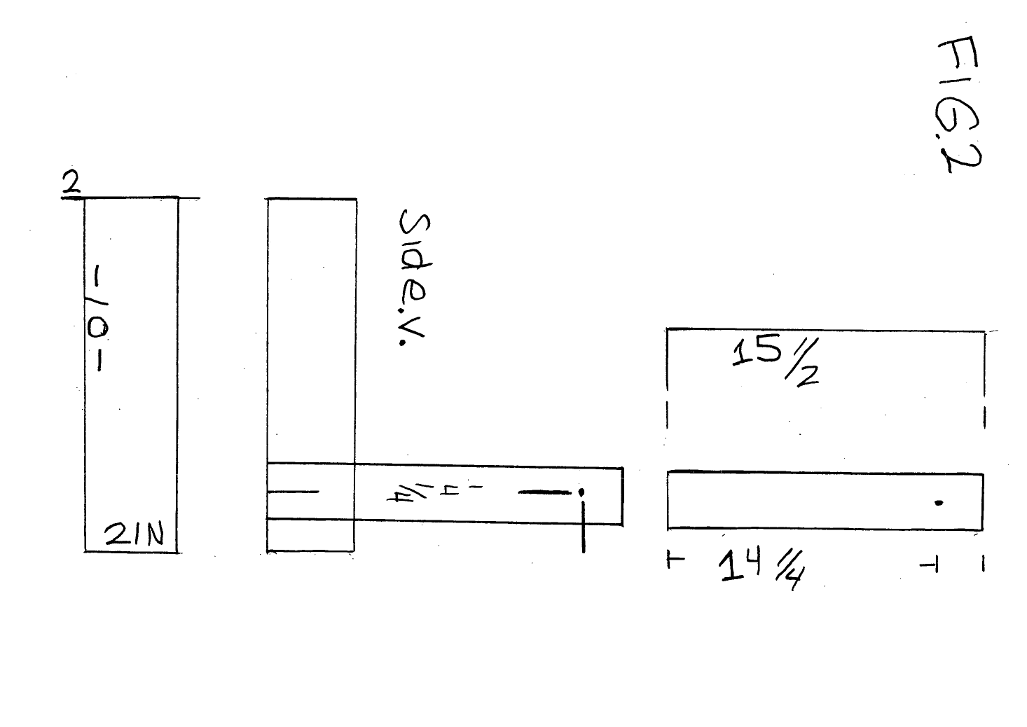

FIG. 2. A side view of the invention of the square gas can rack:

Handle rod locking slide hole, lock rod and design of invention base of rack of FIG. 1 top view.

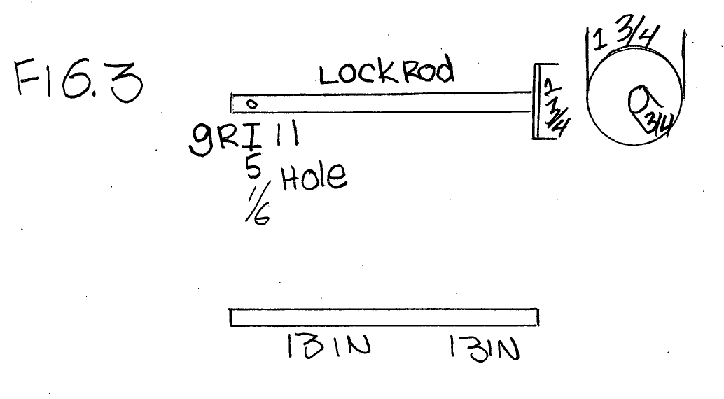

FIG. 3. Lock rod design of the invention:

Lock hole rod, slide into the side base wall square gas can rack shown in FIG. 1. See FIG. 2 for slide hole tube mount down base view and rod hole.

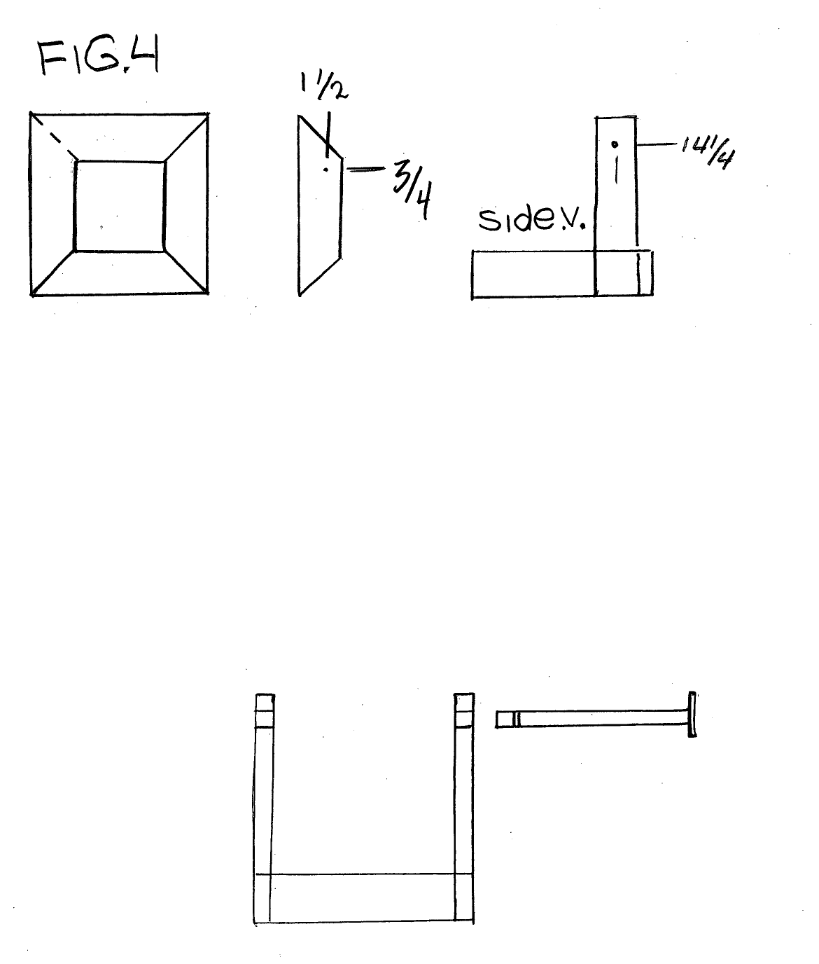

FIG. 4. All views FIG. 1 FIG. 2 FIG.3

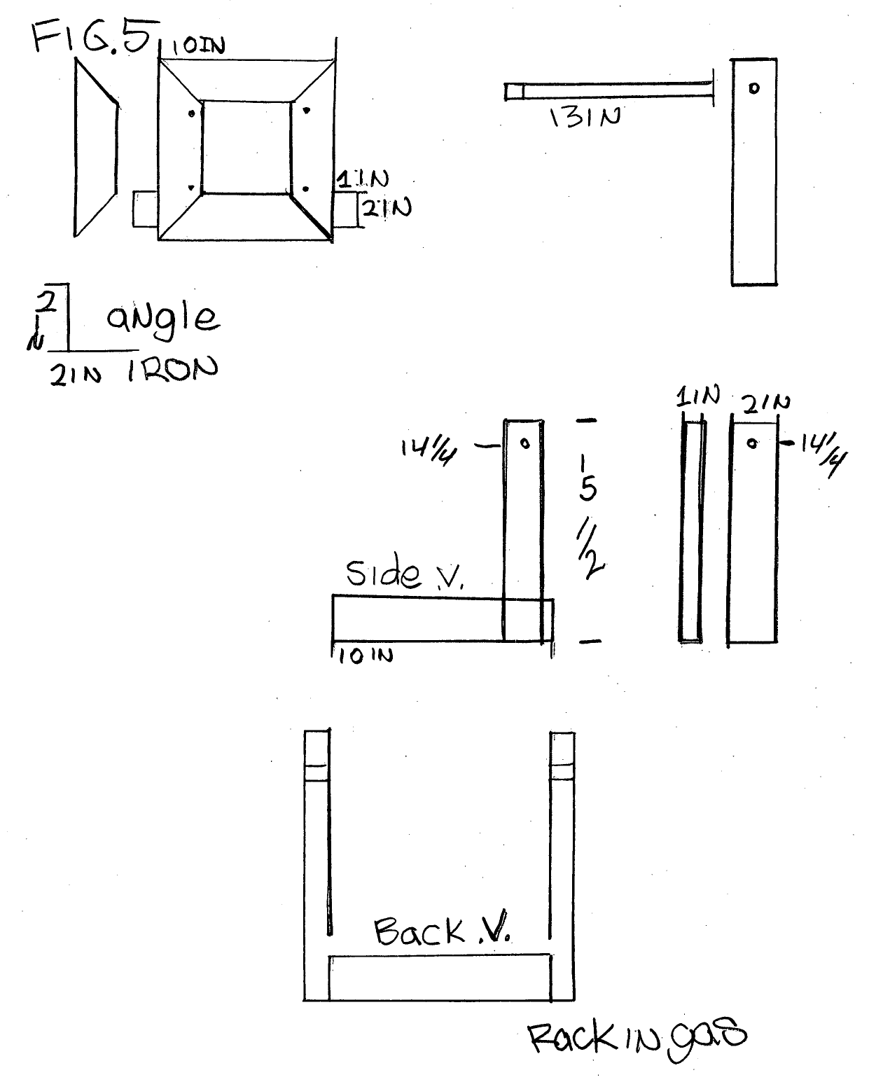

FIG. 5. Back view of the invention:

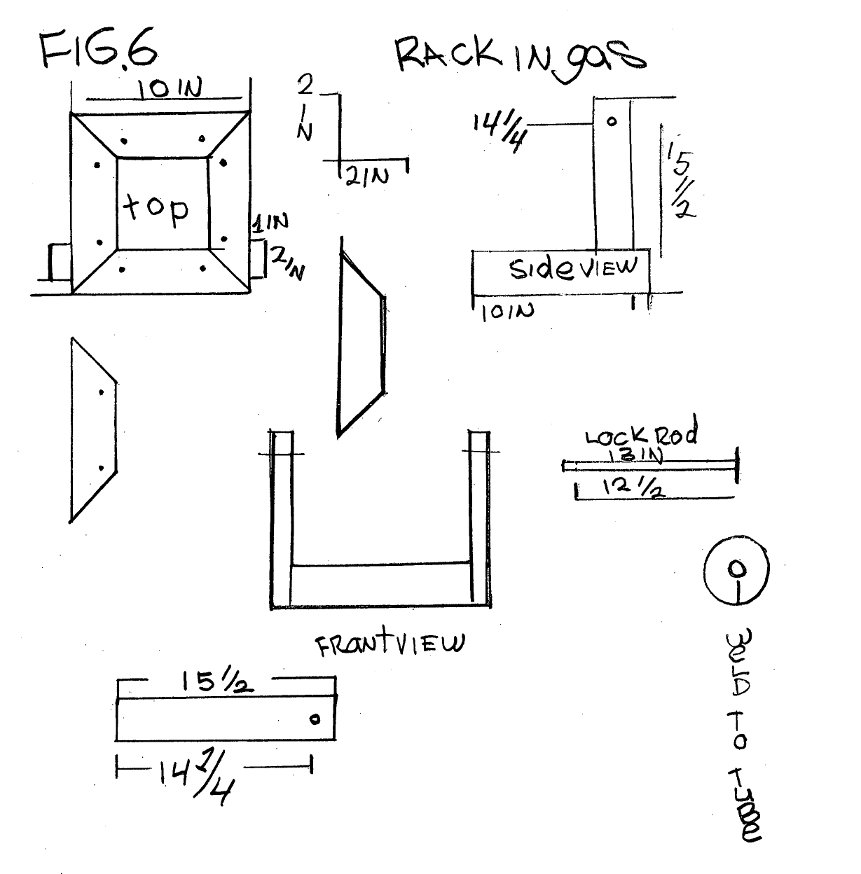

Square gas can rack shown of invention all views FIG. 4 FIG. 6

FIG. 6. The name of the invention of square 5 U.S. gallons gas can rack holder, safety rack is “Rack in Gas”,

All views shown prints FIG.4 FIG. 5.

### PARTS LIST AND MATERIALS

1 # A Four pieces of angle iron.

2 # B Two Pieces of 1 by 2 box tubing.

3 # C Lock rod tubing for tank lock down.

### Parts List, Materials and Measurements

1 # A Four pieces of angle iron cut 10 inches long, 45 degree angle cuts, square base rock, drill holes in angle iron 2 holes in one piece of angle iron as shown prints FIGS. 1, 2, 4, 5, 6.

2 # B Two pieces of 1 by 2 box tubing cut at 15½ inches caped off top and bottom tube, drill hole for lock rod as shown print FIG. 2. Center hole for top to bottom shown lock rod handle FIGS. 2, 4, 5, 6 for rack design.

3 # C Lock rod handle parts shown FIGS. 3, 4, 5, 6 one tube cut at 13 inches long, tube size ½ O.D. (outer diameter), 16 gauge wall thickness, lock ring, lock rod.

Measurements and lock rod 1¾ ring-¾ center hold weld on ring to tube. Lock drill hole size 5/16 drill hole.

1. An improved design for a rack which holds a 5 U.S. gallon plastic gas can, as shown and described.

2. The rack easily mounts inside the bed of a truck or trailer.

3. The rack safely locks through the handle of a plastic square gas can.

4. The rack can be used for any application for the buyers needs.

5. The gas can is locked in the rack which offers anti-theft and anti-spill.

6. The rack allows peace of mind knowing your gas is in the rack.
